(19) United States
(12) Patent Application Publication
(10) Pub. No.: US 2026/0162950 A1
(43) Pub. Date: Jun. 11, 2026

(54) Systems and Methods for Performing Reference-Based Tandem Mass Spectrometry

(71) Applicant: Thermo Fisher Scientific (Bremen) GmbH, Bremen (DE)

(72) Inventor: Markus Kellmann, Harpstedt (DE)

(21) Appl. No.: 18/975,551

(22) Filed: Dec. 10, 2024

(51) Int. Cl. H01J 49/00; G01N 30/02; G01N 30/72

(52) U.S. Cl. CPC H01J 49/004; G01N 30/7233; G01N 2030/027

(57) ABSTRACT

An illustrative method of performing reference-based data-dependent tandem mass spectrometry includes directing a mass spectrometer to acquire an MS1 mass spectrum of ions produced from a sample, identifying, based on the MS1 mass spectrum, an observed precursor ion that corresponds to a target ion included in an inclusion list, directing, based on the identifying of the observed precursor ion, the mass spectrometer to acquire an MS2 mass spectrum associated with the observed precursor ion, and removing, when the acquired MS2 mass spectrum associated with the observed precursor ion is within a threshold similarity of a reference MS2 mass spectrum associated with the target ion, the target ion from the inclusion list.

### BACKGROUND INFORMATION

A mass spectrometer is a sensitive instrument that may be used to detect, identify, and/or quantify molecules based on their mass-to-charge ratio (m/z). As an illustrative example, peptides, proteins, and related molecules may be detected, identified, and/or quantified in a complex biological sample using a mass spectrometer. A mass spectrometer generally includes an ion source for generating ions from components included in a sample, a mass analyzer for separating the ions based on their m/z, and an ion detector for detecting the separated ions. The mass spectrometer may be connected to a computer-based software platform that uses data from the ion detector to construct a mass spectrum that represents a relative abundance of each of the detected ions as a function of m/z. The m/z of ions may be used to detect and quantify molecules in simple and complex mixtures. A separation device such as a liquid chromatograph, gas chromatograph, or capillary electrophoresis device may be coupled to the mass spectrometer to separate analytes included in the sample before the analytes are introduced to the mass spectrometer.

Tandem mass spectrometry is a technique that analyzes, in two or more successive stages, ions produced by the fragmentation, activation, and/or dissociation of precursor ions and/or product ions (e.g., ions produced by dissociation or fragmentation of precursor ions that were formed themselves by earlier or intermediate dissociation or fragmentation stages). Tandem mass spectrometry most often occurs in two stages and is typically referred to as mass spectrometry/mass spectrometry (MS/MS or MS2). In a data-dependent acquisition (DDA) procedure for tandem mass spectrometry, a survey acquisition (e.g., a full-spectrum MS scan) is performed over a wide precursor m/z range (typically referred to as an MS1 scan or acquisition). A number of precursor ions whose m/z values were recorded in the MS1 scan are selected, using predetermined rules, and subjected to one or more additional stages of mass analysis to generate product ion mass spectra. These additional stages of mass analyses are typically referred to as MS/MS or MS2 scans, acquisitions, or analyses.

The DDA procedure makes efficient use of resources of the mass spectrometer by performing a costly MS2 analysis on a selected m/z only when the presence of a component of interest eluting from the separation device is confirmed by the MS1 survey acquisition. However, such efficiencies are curtailed when certain ions observed in the survey acquisition, such as precursor ions observed in the survey acquisition, are selected for MS2 analyses solely based on decreasing levels of intensity associated with the ions, which may produce redundant or uninformative mass spectra data. Moreover, when another analysis of the same sample or comparative analysis on other samples is performed, some components of interest may be measured in one experiment but not in others. This frustrates attempts to perform reproducible analyses and is known as the “missing value problem”.

### SUMMARY

The following description presents a simplified summary of one or more aspects of the methods and systems described herein in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the methods and systems described herein in a simplified form as a prelude to the more detailed description that is presented below.

In some illustrative embodiments, a system comprises a memory storing instructions and a processor communicatively coupled to the memory and configured to execute the instructions to perform a process comprising: directing a mass spectrometer to acquire an MS1 mass spectrum of ions produced from a sample; identifying, based on the MS1 mass spectrum, an observed precursor ion that corresponds to a target ion included in an inclusion list, wherein the inclusion list is used to select one or more precursor ions observed in the MS1 spectrum for an MS2 acquisition; directing, based on the identifying of the observed precursor ion, the mass spectrometer to acquire an MS2 mass spectrum associated with the observed precursor ion; and removing, when the acquired MS2 mass spectrum associated with the observed precursor ion is within a threshold similarity of a reference MS2 mass spectrum associated with the target ion, the target ion from the inclusion list.

In some illustrative embodiments, a system comprises a mass spectrometer configured to acquire mass spectra for ions produced from a sample and a controller communicatively coupled with the mass spectrometer and configured to: direct the mass spectrometer to acquire an MS1 mass spectrum of ions produced from the sample; identify, based on the MS1 mass spectrum, an observed precursor ion that corresponds to a target ion included in an inclusion list, wherein the inclusion list is used to select one or more precursor ions observed in the MS1 spectrum for an MS2 acquisition; direct, based on the identifying of the observed precursor ion, the mass spectrometer to acquire an MS2 mass spectrum associated with the observed precursor ion; and remove, when the acquired MS2 mass spectrum associated with the observed precursor ion is within a threshold similarity of a reference MS2 mass spectrum associated with the target ion, the target ion from the inclusion list.

In some illustrative embodiments, a computer program product embodied on a non-transitory computer-readable medium comprises instructions that, when executed, direct at least one processor of a computing device for mass spectrometry to perform a process comprising: directing a mass spectrometer to acquire an MS1 mass spectrum of ions produced from a sample; identifying, based on the MS1 mass spectrum, an observed precursor ion that corresponds to a target ion included in an inclusion list, wherein the inclusion list is used to select one or more precursor ions observed in the MS1 spectrum for an MS2 acquisition; directing, based on the identifying of the observed precursor ion, the mass spectrometer to acquire an MS2 mass spectrum associated with the observed precursor ion; and removing, when the acquired MS2 mass spectrum associated with the observed precursor ion is within a threshold similarity of a reference MS2 mass spectrum associated with the target ion, the target ion from the inclusion list.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative liquid chromatography-mass spectrometry system including a liquid chromatograph and a mass spectrometer.

FIG. 2 shows an illustrative implementation of the mass spectrometer of FIG. 1.

FIG. 3 shows an illustrative mass spectrometry control system.

FIG. 4 shows an illustrative method of performing data-dependent tandem mass spectrometry.

FIG. 5 shows an illustrative mass spectrum.

FIG. 6 shows an illustrative graph of ion signal versus retention time during an elution of two analytes of interest.

FIG. 7 shows an illustrative schematic of separate mass spectra obtained at two different retention times.

FIG. 8 shows an illustrative schematic of performing data-dependent tandem mass spectrometry.

FIG. 9 shows an illustrative method of performing data-dependent tandem mass spectrometry.

FIG. 10 shows an illustrative method of performing tandem mass spectrometry.

FIG. 11 shows an illustrative computing device.

### DETAILED DESCRIPTION

Methods and systems are described herein for performing reference-based tandem mass spectrometry. For example, in data-dependent acquisition (DDA) tandem mass spectrometry, a precursor ion observed in an MS1 mass spectrum is selected for an MS2 acquisition when the precursor ion corresponds to a target ion included in an inclusion list and having a likelihood of determining of one or more analytes of interest in a sample. When an MS2 mass spectrum associated with the selected observed precursor ion is verified to correspond a reference MS2 mass spectrum associated with the target ion (e.g., to confirm the presence of the target ion in the sample), the target ion is removed from the inclusion list to exclude the target ion from another MS2 acquisition. Moreover, mass analysis of the target ion may be used to determine (e.g., to detect, confirm identification of, perform quantification of, derive structural details of, etc.) the one or more analytes of interest in the sample.

To illustrate, a method of performing reference-based DDA tandem mass spectrometry includes acquiring an MS1 mass spectrum of ions produced from a sample and identifying, based on the MS1 mass spectrum, an observed precursor ion that corresponds to a target ion included in an inclusion list (e.g., a list used to select one or more precursor ions observed in the MS1 spectrum for an MS2 acquisition), acquiring an MS2 mass spectrum associated with the observed precursor ion, and removing, when the acquired MS2 mass spectrum associated with the observed precursor ion is within a threshold similarity of a reference MS2 mass spectrum associated with the target ion, the target ion from the inclusion list (e.g., to exclude the target ion from being selected for another MS2 acquisition). For example, when the acquired MS2 mass spectrum associated with the observed precursor ion is within the threshold similarity of the reference MS2 mass spectrum associated with the target ion, the presence of the target ion in the sample is confirmed to allow another observed precursor ion to be selected for MS2 analysis.

Systems and methods described herein may provide various benefits, which may include one or more advantages over conventional systems and methods for performing DDA tandem mass spectrometry. For example, in conventional DDA systems, precursor ions are selected for MS2 acquisition based purely on intensity of the precursor ions in the MS1 mass spectrum without knowing at the time of the MS2 acquisition a likelihood of identification and/or quantification of an analyte based on the precursor ion, resulting in uninformative mass spectra that wastes computing resources of the mass spectrometer. Moreover, when multiple precursor ions have substantially the same intensity in the MS1 mass spectrum, precursor ions are randomly selected for MS2 acquisition, which may lead to incomplete, irreproducible, and/or inaccurate spectral data (e.g., due to the missing value problem).

Conversely, the use of the MS1 mass spectrum to identify an observed precursor ion that corresponds to a target ion included in an inclusion list allows the mass spectrometer to focus MS2 analysis time and effort on targeting higher value precursor ions (e.g., precursor ions having a higher likelihood of determining one or more analytes of interest in the sample) to produce more informative, accurate, and/or reproducible mass spectra. Moreover, removing the target ion from the inclusion list when the acquired MS2 mass spectrum associated with the observed precursor ion is within a threshold similarity of a reference MS2 mass spectrum associated with the target ion increases the efficiency and accuracy of the mass spectrometer. To illustrate, when the acquired MS2 mass spectrum associated with the observed precursor ion is within the threshold similarity of the reference MS2 mass spectrum associated with the target ion, the presence of the target ion in the sample is verified more quickly to allow additional precursor ions to be selected for MS2 analysis by the mass spectrometer, which may increase a number of target ions and/or analytes to be analyzed. Accordingly, compared to conventional systems and methods for performing data-dependent tandem mass spectrometry, systems and methods described herein may improve the results and/or efficiencies of a data-dependent tandem mass spectrometry procedure performed by a mass spectrometer.

Various embodiments will now be described in more detail with reference to the figures. The systems and methods described herein may provide one or more of the benefits mentioned above and/or various additional and/or alternative benefits that will be made apparent herein.

Unless otherwise defined, all other technical and scientific terms used herein have the meaning commonly understood by one of ordinary skill in the art to which this invention belongs. In case of conflict, the present specification, including definitions, will control. As used herein, the term “scan”, when used as a noun, means a mass spectrum, regardless of the type of mass analyzer used to generate and acquire the mass spectrum. When used as a verb herein, the term “scan” refers to the generation and acquisition of a mass spectrum by a method of mass analysis, regardless of the type of mass analyzer or mass analysis used to generate and acquire the mass spectrum. As used herein, the term “full scan” refers to a mass spectrum that encompasses a range of mass-to-charge (m/z) values that includes a plurality of mass spectral peaks. As used herein, the term “MS1” refers to either a mass spectrum or the generation and acquisition of a mass spectrum that pertains to ions received by a mass analyzer from an ion source, including any ions that may have been modified from their initial states by in-source fragmentation. As used herein the term “MS2” refers to either tandem mass spectrometry or a result obtained by the technique of tandem mass spectrometry.

In some implementations, the methods and systems for performing reference-based data-dependent tandem mass spectrometry, as described herein, may be used in conjunction with a combined separation-mass spectrometry system, such as a liquid chromatography-mass spectrometry (LC-MS) system. As such, an LC-MS system will now be described. The described LC-MS system is illustrative and not limiting. The methods and systems described herein may operate as part of or in conjunction with the LC-MS system described herein and/or with any other suitable separation-mass spectrometry system, including a high-performance liquid chromatography-mass spectrometry (HPLC-MS) system, a gas chromatography-mass spectrometry (GC-MS) system, or a capillary electrophoresis-mass spectrometry (CE-MS) system.

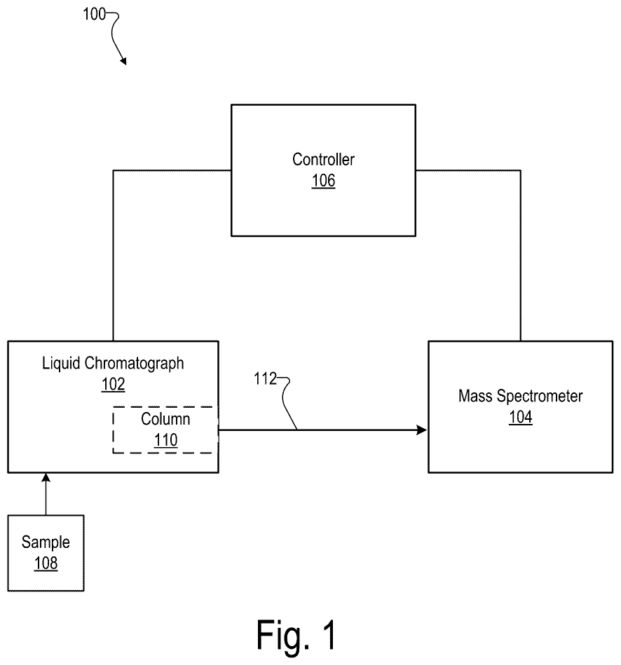

FIG. 1 shows an illustrative LC-MS system 100. LC-MS system 100 includes a liquid chromatograph 102, a mass spectrometer 104, and a controller 106. Liquid chromatograph 102 is configured to separate, over time, analytes (e.g., components) within a sample 108 that is injected into liquid chromatograph 102. Sample 108 may include, for example, chemical analytes (e.g., molecules, ions, etc.) and/or biological analytes (e.g., metabolites, proteins, lipids, etc.) for detection and analysis by LC-MS system 100. Liquid chromatograph 102 may be implemented by any liquid chromatograph as may suit a particular implementation. In liquid chromatograph 102, sample 108 may be injected onto a column 110 and carried through column 110 by a mobile phase (e.g., a solvent). As the mobile phase passes through column 110, analytes within sample 108 elute from column 110 at different times based on, for example, their size, their affinity to the stationary phase, their polarity, and/or their hydrophobicity.

A detector (e.g., a spectrophotometer) may measure the relative intensity of a signal modulated by each separated analyte in eluate 112 from column 110. Data generated by the detector may be represented as a chromatogram, which plots retention time on the x-axis and a signal representative of the relative intensity on the y-axis. The retention time of an analyte is generally measured as the period of time between injection of sample 108 onto column 110 and the relative intensity peak maximum after chromatographic separation. In some examples, the relative intensity may be correlated to or representative of relative abundance of the separated analytes. Data generated by liquid chromatograph 102 may be output to controller 106.

In some cases, particularly in analyses of complex mixtures, multiple different analytes in sample 108 may co-elute from column 110 at approximately the same time, and thus may have the same or similar retention times. As a result, determination of the relative intensity of the individual analytes within sample 108 requires further separation of the individual analytes. To this end, liquid chromatograph 102 directs analytes included in eluate 112 to mass spectrometer 104.

Mass spectrometer 104 is configured to ionize the analytes received from liquid chromatograph 102 and sort or separate the produced ions based on m/z of the ions. A detector in mass spectrometer 104 measures the intensity of the signal produced by the ions. As used herein, “intensity” or “signal intensity” may refer to any suitable metric, such as abundance, relative abundance, ion count, intensity, relative intensity, etc. Data generated based on signals detected by the detector may be represented by mass spectra, which plot the intensity of the observed signal as a function of m/z of the ions. Data acquired by mass spectrometer 104 may be output to controller 106.

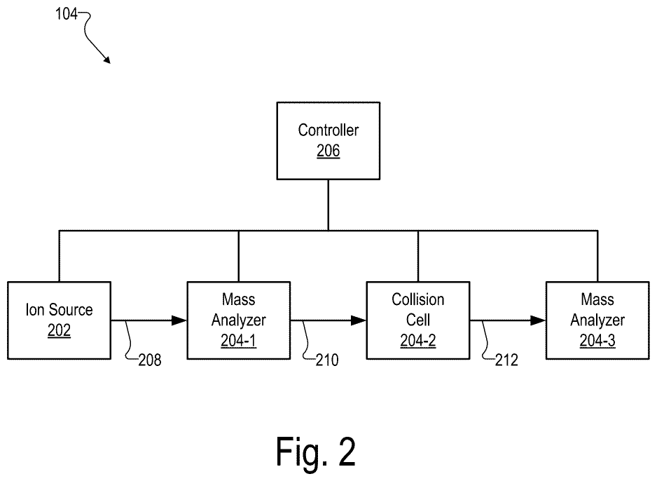

Mass spectrometer 104 may be implemented by any suitable mass spectrometer, such as a tandem mass spectrometer configured to perform tandem mass spectrometry (e.g., MS/MS), a multi-stage mass spectrometer configured to perform multi-stage mass spectrometry (denoted MSⁿ), a mass spectrometer with a single analyzer (e.g., a quadrupole ion trap capable of MS/MS and/or MSn), or a hybrid mass spectrometer that contains multiple analyzers, and the like. FIG. 2 shows an illustrative implementation of mass spectrometer 104. As shown, mass spectrometer 104 is tandem-in-space (e.g., has multiple mass analyzers) and has two stages for performing MS/MS. However, mass spectrometer 104 is not limited to this configuration but may have any other suitable configuration. For example, mass spectrometer 104 may have a single mass analyzer and may be tandem-in-time. Additionally or alternatively, mass spectrometer 104 may be a multi-stage mass spectrometer and may have any suitable number of analyzers and/or stages (e.g., three or more) for performing multi-stage mass spectrometry (e.g., MS/MS/MS).

As shown, mass spectrometer 104 includes an ion source 202, a first mass analyzer 204-1, a collision cell 204-2, a second mass analyzer 204-3, and a controller 206. Mass spectrometer 104 may further include any additional or alternative components not shown as may suit a particular implementation (e.g., ion optics, filters, an autosampler, a detector, etc.).

Ion source 202 is configured to produce a stream 208 of ions from analytes of sample 108 and deliver the ions to first mass analyzer 204-1. Ion source 202 may use any suitable ionization technique, including without limitation electron ionization, chemical ionization, matrix assisted laser desorption/ionization, electrospray ionization, atmospheric pressure chemical ionization, atmospheric pressure photoionization, inductively coupled plasma, and the like. Ion source 202 may include various components for producing ions from analytes included in sample 108 and delivering the ions to first mass analyzer 204-1.

First mass analyzer 204-1 is configured to receive ion stream 208 and direct a beam 210 of ions (e.g., precursor ions) to collision cell 204-2. In an MS2 analysis, collision cell 204-2 is configured to receive beam 210 of ions and produce product ions (e.g., fragment ions) via one or more controlled dissociation processes. Collision cell 204-2 is further configured to direct a beam 212 of product ions to second mass analyzer 204-3. Second mass analyzer 204-3 is configured to filter and/or perform a mass analysis of the product ions.

Mass analyzers 204-1 and 204-3 are configured to separate ions according to m/z of each of the ions. Mass analyzers 204-1 and 204-3 may be implemented by any suitable mass analyzer, such as a quadrupole mass filter, an ion trap (e.g., a three-dimensional quadrupole ion trap, a cylindrical ion trap, a linear quadrupole ion trap, a toroidal ion trap, etc.), a time-of-flight (TOF) mass analyzer, an electrostatic trap mass analyzer (e.g. an orbital electrostatic trap such as an Orbitrap mass analyzer, a Kingdon trap, etc.), a Fourier transform ion cyclotron resonance (FT-ICR) mass analyzer, a sector mass analyzer, and the like. In some embodiments, mass analyzers 204 may be implemented by the same type of mass analyzer. However, mass analyzers 204 need not be implemented by the same type of mass analyzer in other embodiments.

Collision cell 204-2 may be implemented by any suitable collision cell. As used herein, “collision cell” may encompass any structure or device configured to produce product ions via one or more controlled dissociation processes and is not limited to devices employed for collisionally-activated dissociation. For example, collision cell 204-2 may be configured to fragment precursor ions using collision induced dissociation, electron transfer dissociation, electron capture dissociation, photon induced dissociation, surface induced dissociation, ion/molecule reactions, and the like.

An ion detector (not shown) is configured to detect ions at each of a variety of different m/z and responsively generate a signal (e.g., an electrical signal or a photon-based signal) representative of ion intensity. The signal is transmitted to controller 206 for processing, such as to construct a mass spectrum of the sample. For example, mass analyzer 204-3 may emit an emission beam of separated ions to the ion detector, which is configured to detect the ions in the emission beam and generate or provide data that can be used by controller 206 to construct a mass spectrum of the sample. The ion detector may be implemented by any suitable detection device, including without limitation an electron multiplier, a Faraday cup, a photon-based detector, and the like. The ion detector may be implemented in the mass spectrometer in any suitable way, including as part of mass analyzer 204-3, for example.

Controller 206 may be communicatively coupled with and configured to control operations of ion source 202, mass analyzer 204-1, collision cell 204-2, and mass analyzer 204-3 of mass spectrometer 104. For example, controller 206 may be configured to control operation of various hardware components included in ion source 202, collision cell 204-2, and/or mass analyzers 204-1 and 204-3. To illustrate, controller 206 may be configured to control an accumulation time of ion source 202 and/or mass analyzers 204, control an oscillatory voltage power supply and/or a DC power supply to supply an RF voltage and/or a DC voltage to mass analyzers 204, adjust values of the RF voltage and DC voltage to select an effective m/z (including a mass tolerance window) for analysis, and adjust the sensitivity of the ion detector (e.g., by adjusting the detector gain).

Controller 206 may also include and/or provide a user interface configured to enable interaction between a user of mass spectrometer 104 and controller 206. The user may interact with controller 206 via the user interface by tactile, visual, auditory, and/or other sensory type communication. For example, the user interface may include a display device (e.g., liquid crystal display (LCD) display screen, a touch screen, etc.) for displaying information (e.g., mass spectra, notifications, etc.) to the user. The user interface may also include an input device (e.g., a keyboard, a mouse, a touchscreen device, etc.) that allows the user to provide input to controller 206. In other examples the display device and/or input device may be separate from, but communicatively coupled to, controller 206. For instance, the display device and the input device may be included in a computer (e.g., a desktop computer, a laptop computer, etc.) communicatively connected to controller 206 by way of a wired connection (e.g., by one or more cables) and/or a wireless connection.

Controller 206 may include any suitable hardware (e.g., a processor, circuitry, etc.) and/or software as may serve a particular implementation. While FIG. 2 shows that controller 206 is included in mass spectrometer 104, controller 206 may alternatively be implemented in whole or in part separately from mass spectrometer 104, such as by a computing device communicatively coupled to mass spectrometer 104 by way of a wired connection (e.g., a cable), a wireless connection, and/or a network (e.g., a local area network, a wireless network (e.g., Wi-Fi), a wide area network, the Internet, a cellular data network, etc.). In some examples, controller 206 may be implemented in whole or in part by controller 106.

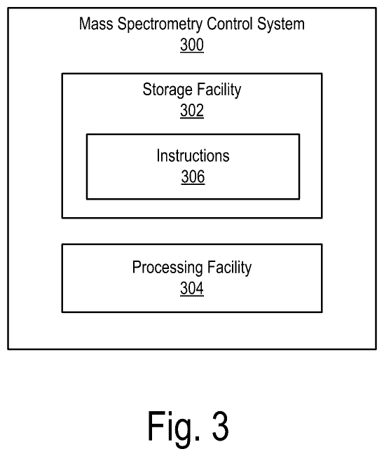

Controller 206 may include or otherwise implement a mass spectrometry control system, which may be configured to perform one or more operations of data-dependent tandem mass spectrometry described herein. FIG. 3 shows an illustrative mass spectrometry control system 300 (“system 300”). System 300 may be implemented entirely or in part by LC-MS system 100 and/or mass spectrometer 104 (e.g., by controller 106 and/or controller 206). Alternatively, system 300 may be implemented separately from LC-MS system 100.

System 300 may include, without limitation, a storage facility 302 and a processing facility 304 selectively and communicatively coupled to one another. Facilities 302 and 304 may each include or be implemented by hardware and/or software components (e.g., processors, memories, communication interfaces, instructions stored in memory for execution by the processors, etc.). In some examples, facilities 302 and 304 may be distributed between multiple devices and/or multiple locations as may serve a particular implementation.

Storage facility 302 may maintain (e.g., store) executable data used by processing facility 304 to perform one or more of the illustrative operations described herein. For example, storage facility 302 may store instructions 306 that may be executed by processing facility 304 to perform one or more of the operations described herein. Instructions 306 may be implemented by any suitable application, software, code, and/or other executable data instance.

Storage facility 302 may also maintain any data acquired, received, generated, managed, used, and/or transmitted by processing facility 304. For example, storage facility 302 may maintain data acquired by processing facility 304 from one or more components of system 100 (e.g., acquired chromatogram data and/or mass spectra data), data acquired by processing facility 304 from one or more other sources, and/or data generated by processing facility 304. Any of the data described herein (e.g., any of the datasets described herein, such as mass spectra data) may be maintained by storage facility 302 and/or by a separate storage facility communicatively coupled to system 300.

Processing facility 304 may be configured to perform (e.g., execute instructions 306 stored in storage facility 302 to perform) various processing operations described herein. It will be recognized that the operations and examples described herein are merely illustrative of the many different types of operations that may be performed by processing facility 304. In the description herein, any references to operations performed by system 300 may be understood to be performed by processing facility 304 of system 300. Furthermore, in the description herein, any operations performed by system 300 may be understood to include system 300 directing or instructing another system or device (e.g., one or more components of mass spectrometer 104 or system 100) to perform the operations.

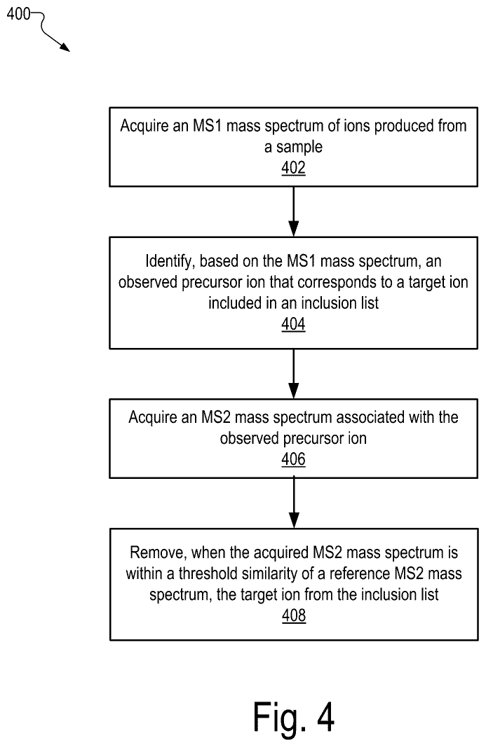

FIG. 4 shows an illustrative method 400 of performing reference-based data-dependent tandem mass spectrometry. While FIG. 4 shows illustrative operations according to one embodiment, other embodiments may omit, add to, reorder, and/or modify any of the operations shown in FIG. 4. One or more of the operations shown in FIG. 4 may be performed by LC-MS system 100, mass spectrometer 104, and/or system 300, any components included therein, and/or any implementations thereof.

As shown in FIG. 4, method 400 includes acquiring an MS1 mass spectrum of ions produced from a sample at operation 402, identifying, based on the MS1 mass spectrum, an observed precursor ion that corresponds to a target ion included in an inclusion list at operation 404, acquiring an MS2 mass spectrum associated with the observed precursor ion at operation 406, and removing, when the acquired MS2 mass spectrum is within a threshold similarity of a reference MS2 mass spectrum, the target ion from the inclusion list at operation 408. Operations 402-408 will now be described in more detail.

In operation 402, an MS1 mass spectrum of precursor ions produced from a sample is acquired. For example, as shown in FIG. 1, liquid chromatograph 102 supplies sample 108 to column 110 and directs analytes included in sample 108 and that elute from column 110 to mass spectrometer 104. Mass spectrometer 104 performs a first stage of a DDA procedure that includes performing a full scan MS1 survey acquisition as the analytes elute from column 110. Mass spectrometer 104 acquires MS1 data for the MS1 acquisition, which may be representative of signals detected by mass spectrometer 104 during the MS1 survey acquisition. Based on the MS1 data, mass spectrometer 104 generates an MS1 mass spectrum including intensity values of precursor ions produced from the analytes of sample 108 as a function of m/z of the precursor ions.

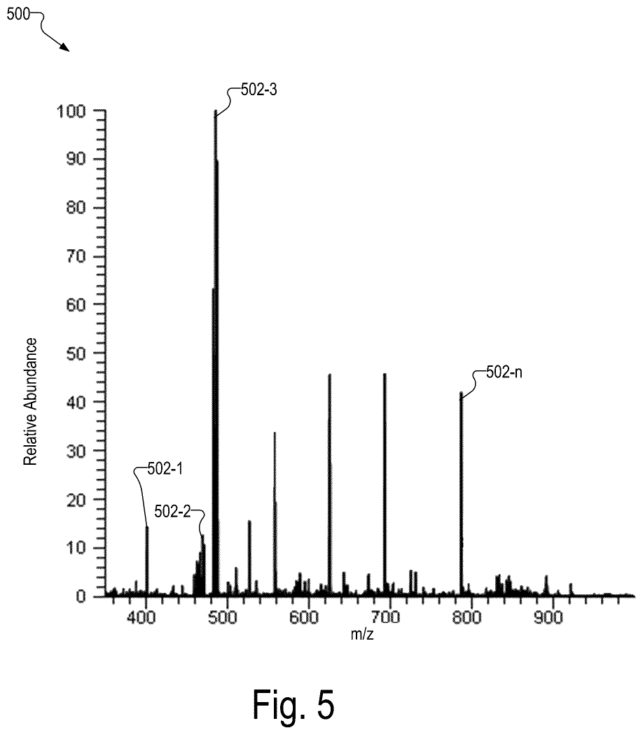

FIG. 5 shows an illustrative mass spectrum 500 that may be representative of the MS1 mass spectrum acquired at operation 402, though any other suitable mass spectrum for any suitable workflow may be acquired at operation 402. Mass spectrum 500 indicates observed features of the MS1 acquisition performed by mass spectrometer 104. As shown, mass spectrum 500 represents the intensity values (e.g., relative abundance along the y axis) of precursor ions produced from analytes of sample 108 as a function of m/z of the precursor ions (m/z along the x axis). Mass spectrum 500 includes a plurality of peaks 502 (e.g., peaks 502-1 through 502-n) at various m/z indicative of the relative abundance of precursor ions corresponding to the m/z that are observed by mass spectrometer 104 during the MS1 acquisition. For example, a first peak 502-1 may represent a first observed precursor ion (e.g., having m/z values of approximately 400), a second peak 502-2 may represent a second observed precursor ion (e.g., having m/z values of approximately 475), and a third peak 502-3 may represent a third observed precursor ion (e.g., having m/z values of approximately 485). Third peak 502-3, which is a feature of mass spectrum 500 typically referred to as the base peak, indicates that the third precursor ion is the most abundant precursor ion observed in the MS1 acquisition.

In some cases, based on MS2 analysis criteria, one or more precursor ions having m/z values corresponding to one or more of peaks 502 may be selected for MS2 analysis. To illustrate, in a DDA procedure in which mass spectrum 500 is an MS1 mass spectrum, features of mass spectrum 500 are used by mass spectrometer 104 to select which of the precursor ions observed in the MS1 acquisition will be subjected to MS2 analysis. To this end, MS2 analysis criteria are defined and used to select which of the observed precursor ions to subject to MS2 analysis. Any simple or complex criteria may be defined and used. As an example, the MS2 analysis criteria may be defined to cause mass spectrometer 104 to select N number of precursor ions that are most abundant in the MS1 scan. As another example, the MS2 analysis criteria may be defined to cause mass spectrometer 104 to select N number of precursor ions that are most abundant within a defined range of m/z values (e.g., m/z values between 400 and 800). As another example, the MS2 analysis criteria may be defined to cause mass spectrometer 104 to select N number of precursor ions that are most abundant within a defined range of m/z values and have charge values of at least 2. Thus, the MS2 analysis criteria may be defined to specify any combination of factors (e.g., intensity, charge state, m/z values, m/z ranges, time periods, isotope distribution, etc.) and rules to be used to select ions for MS2 analysis.

As mentioned above, in a conventional DDA procedure, precursor ions observed in the MS1 acquisition having the highest intensity values (e.g., the most abundant precursor ions) may be subjected to MS2 analysis when the signals of the precursor ions satisfy the MS2 analysis criteria. For example, the third precursor ion having m/z values corresponding to third peak 502-3 may be selected for MS2 analysis purely based on the third precursor ion having the most abundant precursor ion observed in the MS1 acquisition without knowing a likelihood of determining one or more analytes included in sample 108 based on the third precursor ion. Method 400 may prevent this uninformed selection of the precursor ion from occurring, including in scenarios where signals of observed product ions otherwise satisfy the MS2 analysis criteria.

Returning to FIG. 4, in operation 404, an observed precursor ion is identified, based on the MS1 mass spectrum, that corresponds to a target ion included in an inclusion list. As such, the inclusion list is used to select one or more precursor ions observed in the MS1 mass spectrum for an MS2 acquisition. For example, the one or more target ions included in the inclusion list comprise one or more ions (e.g., precursor ions and/or product ions) known to be and/or expected to be in the sample that are desired for analysis (e.g., each target ion is informative in determining one or more analytes of interest known to be and/or expected to be in the sample and desired for analysis such that the one or more analytes may be determined based on mass analysis of the target ion). The identification of the observed precursor ion is performed by comparing precursor ions observed in the MS1 mass spectrum against target ions included in the inclusion list. For example, m/z values of the observed precursor ions are compared with m/z values of the target ions. Based on results of the comparison, a precursor ion observed in the MS1 mass spectrum that corresponds to a target ion in the inclusion list is designated for an MS2 acquisition (e.g., the m/z values of the observed precursor ion are the same or approximate to the m/z values of the corresponding target ion). Accordingly, the observed precursor ion represents a precursor ion that is expected for sample 108 and is also observed in the MS1 mass spectrum.

In some examples, the inclusion list of one or more target ions is generated based on a reference dataset including data representative of one or more target ions associated with sample 108. To illustrate, the one or more target ions included in the inclusion list may be extracted (e.g., queried and/or derived) from the data included in the reference dataset (e.g., the reference dataset includes data representative of m/z values associated with the one or more target ions). As an illustrative example, the data included in the reference dataset comprises spectral data (e.g., one or more mass spectra, such as acquired and/or expected MS1 mass spectra and/or MS2 mass spectra) based on ions included in sample 108 (e.g., the spectral data may include mass spectra having a plurality of peaks at various m/z indicative of the relative abundance of target ions). Any of the possible target ions identified in the reference dataset may be included in the inclusion list of target ions, such as target ions informative in determining one or more analytes of interest known to be and/or expected to be in the sample. For example, the reference dataset may further include a mapping of analytes included in sample 108 to target ions that are expected for the analytes such that the target ions included in the inclusion list are selected based on the mapping.

The reference dataset may further include data representative of one or more properties associated with the one or more target ions that may be extracted from the reference dataset, such as one or more of precursor ions associated with the one or more target ions, product ions associated with the one or more target ions, MS1 mass spectra associated with the one or more target ions, MS2 mass spectra associated with the one or more target ions, intensities associated with the one or more target ions, elution profiles associated with the one or more target ions, m/z values associated with the one or more target ions, interferences associated with the one or more target ions, redundancies associated with the one or more target ions, a likelihood of determining one or more analytes associated with the one or more target ions, chemical compositions associated with the one or more target ions, structural data (e.g., peptide sequence) associated with the one or more target ions, charge states associated with the one or more target ions, or retention times associated with the one or more target ions. Accordingly, the reference dataset may be used to generate the inclusion list as well as tailor spectral measurements performed based on the one or more target ions included in the inclusion list.

In some instances, the reference dataset is generated in advance of acquiring the MS1 mass spectrum at operation 402. To illustrate, the reference dataset may include data acquired from previously performed MS1 acquisitions and/or MS2 acquisitions (e.g., associated with sample 108 and/or a comparative sample). Additionally or alternatively, reference dataset may include data acquired from querying an existing database. To illustrate, one or more analytes included in sample 108 are known such that expected precursor ions and/or product ions associated with the one or more known analytes may be stored in a database and queried for generating the reference dataset. As an illustrative example, the reference dataset may include a peptide database derived from a genome or a previously acquired spectral library.

Additionally or alternatively, the reference dataset is generated based on acquiring the MS1 mass spectrum at operation 402. For example, the acquiring the MS1 mass spectrum at operation 402 may include performing a full scan MS1 survey acquisition of sample 108 such that the reference dataset is generated from spectral data acquired from the full scan MS1 survey acquisition.

In some examples, the reference dataset is generated based on pooled sample of a combination of multiple samples such that the reference dataset may, in some instances, include identifications (e.g., labels) of the multiple combined samples, such as tandem mass tag (TMT) reagents or isobaric tags for relative and absolute quantitation (iTRAQ®) (AB Sciex Pte. Ltd.) reagents, which may increase sample throughput. In brief, isobaric tags are compounds that react with and attach to peptides. Isobaric tags have two regions: a reporter region and a balance region. Versions of isobaric tags have been created that all have the same exact total mass of reporter region plus balance region, but the reporter region mass and the balance region mass for each version is different. Multiple individual samples may be multiplexed by labeling analytes (e.g., peptides) in each sample with a different version of the isobaric tag, mixing all the samples together, and analyzing the combined samples via LC-MS or GC-MS in one experiment. The same isobaric tag-labeled peptides across the various individual samples all have the same m/z, but when they are fragmented by MS2 the reporter region of the isobaric tag falls off and reporter ions of different m/z may be analyzed by MS2. The relative intensity of the reporter ions at their various m/z are indicative of the relative concentrations of analytes in each individual sample. In some examples, the reference dataset is acquired by measuring (e.g., in one or more measurement runs) the pooled sample. Moreover, in instances where the reference dataset is generated based on a pooled sample, sample 108 may include one respective (e.g., replicate) sample included in the multiple pooled samples. Additionally or alternatively, the reference dataset is generated based on a non-pooled sample (e.g., using Gas Phase Fractionation, LC-Fractionation, etc.).

The reference dataset may be stored in any storage facility (e.g., storage facility 302) that is accessible to system 300. The reference dataset may be implemented in any suitable format for storing data for access by system 300, such as a database that is populated prior to and/or after the MS1 acquisition.

In some scenarios, a plurality of precursor ions are observed in the MS1 mass spectrum that correspond to target ions in the inclusion list such that the plurality of precursor ions may produce more product ions than the mass spectrometer can effectively measure in an MS2 acquisition. In such scenarios, a subset of one or more precursor ions included in the plurality of precursor ions are selected for the MS2 acquisition. For example, precursor ions included in the plurality of observed precursor ions may be added to a candidate list of observed precursor ions, such as by adding the m/z values of the observed precursor ions to a list of m/z values in the candidate list. The identifying the observed precursor ion may therefore include selecting the observed precursor ion (or a subset of precursor ions) from the candidate list.

In some examples, the observed precursor ion is identified by ranking the plurality of observed precursor ions in the candidate list and selecting an observed precursor ion ranked above another observed precursor ion (e.g., the highest-ranking observed precursor ion or subset of precursor ions). To illustrate, the observed precursor ions are ranked according to one or more factors such as one or more of an intensity of the observed precursor ions (e.g., a precursor ion having a higher intensity is ranked above another precursor ion having a lower intensity), a likelihood of determining one or more analytes included in the sample based on the observed precursor ions (e.g., a precursor ion having a higher likelihood of determining one or more analytes is ranked above another precursor ion having a lower likelihood), unique product ions expected to be produced from the observed precursor ions (e.g., a precursor ion having more unique product ions is ranked above another precursor ion having a lower unique product ions), or interferences (e.g., m/z values associated with a precursor ion that interferes or overlaps with m/z values associated with another precursor ion) associated with the observed precursor ions (e.g., a precursor ion having less interference is ranked above another precursor ion having more interference). The one or more factors may be weighted to rank the plurality of observed precursor ions (e.g., likelihood of determining one or more analytes included in the sample based on the observed precursor ions may be weighted above the intensity of the observed precursor ions).

Where the MS1 mass spectrum is mass spectrum 500 shown in FIG. 5, for example, the observed precursor ions in mass spectrum 500 are compared to target ions in the inclusion list to identify observed precursor ions that correspond to one or more target ions. For instance, m/z values of observed precursor ions in mass spectrum 500, such as the m/z values associated with one or more of peaks 502 (e.g., all of peaks 502, peaks 502 representing intensities above an intensity threshold, or peaks 502 at particular m/z values) in mass spectrum 500, may be compared against m/z values of target ions in the inclusion list to identify observed precursor ions having m/z values that are the same or similar to the m/z values of the target ions. To illustrate, a corresponding target ion may be found in the inclusion list for the m/z values associated with first peak 502-1 and third peak 502-3 that represent first and third observed precursor ions respectively, while no corresponding target ion may be found in the inclusion list for the m/z value associated with second peak 502-2 that represents second observed precursor ion (e.g., the second observed precursor ion is not associated with a target ion and/or an analyte of interest).

Accordingly, the first precursor ion and/or the third precursor ion may be selected as the observed precursor ion for MS2 acquisition. In some instances, one of the first precursor ion or the third precursor ion is selected as the observed precursor ion for an initial MS2 acquisition. For example, the first precursor ion and the third precursor ion may be added to a candidate list and ranked according to the one or more factors. While the intensity of the third precursor ion is greater than the intensity of the first precursor ion, the first precursor ion may have a higher likelihood of determining one or more analytes in the sample and/or is expected to produce more unique product ions than the third precursor ion such that the first precursor ion may be selected as the observed precursor ion for the initial MS2 acquisition over the third precursor ion.

Referring back to FIG. 4, in operation 406, an MS2 mass spectrum associated with the identified observed precursor ion is acquired. For example, mass spectrometer 104 acquires MS2 data for product ions produced from the observed precursor ion identified in the MS1 mass spectrum during the MS2 acquisition, where the MS2 data is representative of signals detected by mass spectrometer 104 during the MS2 acquisition. Based on the MS2 data, mass spectrometer 104 generates an MS2 mass spectrum including intensity values of product ions produced from the observed precursor ion as a function of m/z of the product ions. The MS2 mass spectrum may be acquired according to one or more acquisition parameters associated with the observed precursor ion, such as one or more of a collisional energy, a collection time, an acquisition time, an injection time, an elution time, or a retention time. In some examples, the one or more acquisition parameters are determined based on the reference dataset (e.g., based on one or more properties of the target ion corresponding to the identified observed precursor ion and associated with the one or more acquisition parameters).

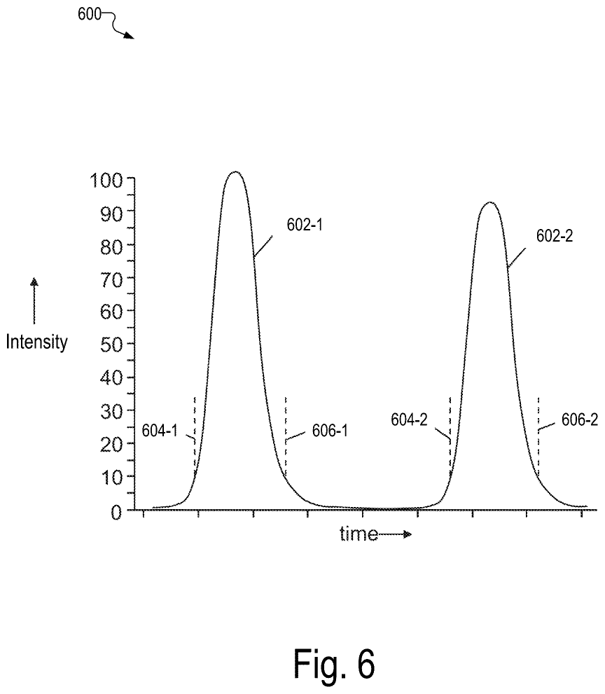

As an illustrative example, the one or more acquisition parameters may include a retention time such that the MS2 mass spectrum for the observed precursor ion is acquired during a retention time window (e.g., a range of expected elution times) associated with the corresponding target ion. This is often referred to as “run-time scheduling”. FIG. 6 shows an illustrative schematic 600 of an elution profile of a selected m/z (e.g., representative of an observed precursor ion) that plots intensity amplitude as a function of time. Time is generally measured beginning from injection of the sample to the separation system. For chromatographic separation applications, an analyte's elution time refers to retention time, which is generally measured as the period of time between injection of the sample into the mobile phase and the relative intensity peak maximum after chromatographic separation. For capillary electrophoresis applications, in which analytes are not retained but instead continuously migrate, an analyte's elution time refers to migration time. Migration time is generally measured as the period of time taken for an analyte to migrate from the beginning of the capillary to a detection location. For ion mobility separations, an analyte's elution time refers to drift time of the analyte through a buffer gas, which may take place either in-space (e.g. a drift tube) or in-time (e.g. a trapped ion mobility cell).

As analytes elute, the detected intensity of precursor ions produced from the analytes form elution peaks 602 (e.g., elution peaks 602-1 through 602-2) having a roughly Gaussian profile, though elution peaks 602 may have other, non-Gaussian profiles. As shown, elution peaks 602 depict intensity amplitudes as might be observed during elution and detection of two analytes of interest, s₁ and s₂, if such analytes are present in sample 108. These two analytes may be part of a larger set of A total targeted analytes {s₁, s₂, . . . , s_{A}} that are being searched for in sample 108 during the mass analysis, wherein each specific analyte may or may not be present in sample 108. A first peak 602-1 represents the contributions of first analyte s₁ (e.g., a precursor ion produced from first analyte s₁) and second peak 602-2 represents the contributions of second analyte s₂ (e.g., a precursor ion produced from second analyte s₂) to the signal. Each peak 602 is detected only during the elution time of the particular respective analyte, if present. Whereas the total run time may be measured in minutes to hours, the width of each peak 602 may only be on the order of seconds.

The times of appearance of the various peaks 602 may be known, such as based on the reference dataset, such that that the times of searching for each analyte (so-called “retention time windows”) may be scheduled in advance. Thus, according to the schedule, the instrument may begin searching for ions (e.g., precursor ions and/or product ions) that are characteristic of first analyte s₁ at a first retention time window start time 604-1 and terminate the search at a first retention time window stop time 606-1. Likewise, the search for ions characteristic of second analyte s₂ may be limited to the time range (or retention time window) between second retention time window start time 604-2 and second retention time window stop time 606-2. Such run-time scheduling may allow spectral measurements for ions associated with each analyte to be more reproducible.

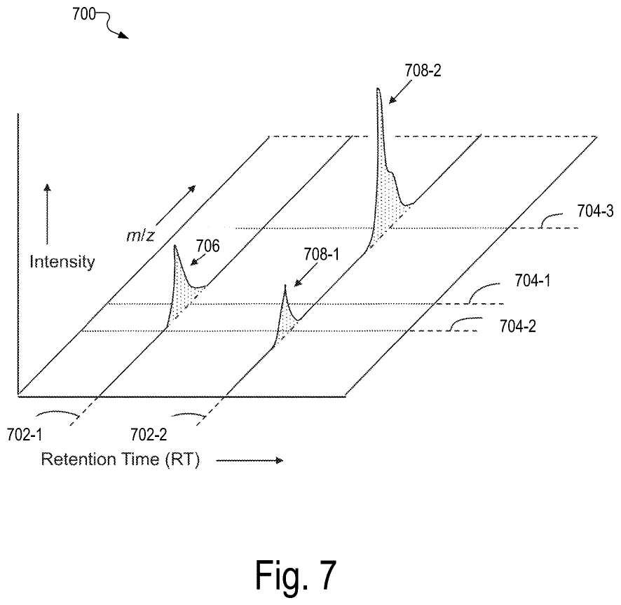

As another illustrative example, during the course of a full scan MS1 survey acquisition, mass spectra are repeatedly obtained (e.g., every 1 second) as retention time increases during the course of elution of analytes from column 110. The complete set of these MS1 mass spectra, which are commonly referred to as “scans”, comprises a two-dimensional (2D) data set of retention time and m/z. As an illustrative example, FIG. 7 shows a schematic 700 of mass spectra as might be obtained at two different retention times during the course of acquiring the full MS1 mass spectra described above. Although only two mass spectra are illustrated, the entire set of additional MS1 mass spectra may comprise a large number of such mass spectra. Each MS1 mass spectrum comprises a set of measured intensities as observed at respective m/z values. Two such mass spectra are illustrated in FIG. 7. As shown, a first mass spectrum is measured at first retention time 702-1 and includes a peak 706 (e.g., representative of a first target ion) located at a first m/z value 704-1. Similarly, a second mass spectrum measured at second retention time 702-2 and includes a first peak 708-1 (e.g., representative of a second target ion) at m/z value 704-2 and a second peak 708-2 (e.g., representative of a third target ion) at m/z value 704-3. Accordingly, the one or more acquisition parameters may include a retention time window such that an MS2 mass spectrum for ions associated with the first target ion is acquired during a first retention time window that includes first retention time 702-1 and MS2 mass spectra for ions associated with the second target ion and/or third target ion are acquired during a second retention time window that includes second retention time 702-2.

Referring back to FIG. 4, in operation 408, the target ion corresponding to the observed precursor ion is removed from the inclusion list when the acquired MS2 mass spectrum associated with the observed precursor ion is within a threshold similarity of a reference MS2 mass spectrum (e.g., a known and/or an expected MS2 mass spectrum) associated with the target ion. For example, the acquired MS2 mass spectrum being within the threshold similarity of the reference MS2 mass spectrum indicates that the observed precursor ion in the MS1 mass spectrum is sufficiently similar to the target ion, verifying that the observed precursor ion does correspond to the target ion. The verification that the observed precursor ion corresponds to the target ion may confirm that the target ion is included in the sample and mass spectra associated with the observed precursor ion may be used to determine one or more analytes of interest associated with the target ion.

When the observed precursor ion is verified to correspond to the target ion, the target ion is removed from the inclusion list to prevent acquiring additional MS2 mass spectra for the target ion. Accordingly, removing the target ion from the inclusion list may allow additional MS2 mass spectra to be acquired based on additional observed precursor ions corresponding to additional target ions, such as during the same retention time window (e.g., to increase a number of target ions able to be effectively measured by mass spectrometer 104). As an illustrative example, if the acquired MS2 mass spectrum for ions associated with the second target ion (e.g., represented by peak 708-1 in FIG. 7) is within the threshold similarity with a reference MS2 mass spectrum associated with the second target ion, the second target ion is removed from the inclusion list and another MS2 mass spectrum may be acquired for ions associated with another target ion (e.g., having a different m/z values, a likelihood of determining one or more analytes in the sample, associated with unique product ions, etc.), such as the third target ion (e.g., represented by peak 708-2 in FIG. 7) during the second retention time window.

In some examples, a reference MS2 spectrum for each target ion (e.g., included in the inclusion list and/or sample) is stored within a spectral library such that operation 408 may include performing a real-time search of the spectral library to identify the reference MS2 mass spectrum associated with the target ion corresponding to the observed precursor ion associated with the acquired MS2 mass spectrum. The spectral library may be implemented in any suitable format for storing data for access by system 300, such as a database that is populated prior to and/or after the MS1 acquisition. Any of the possible MS2 mass spectra associated with target ions in the inclusion list may be included in the spectral library. The real-time library search may be performed for every acquired MS2 mass spectrum of mass spectrometer 104 to compare each acquired MS2 mass spectrum with a reference MS2 mass spectrum in the spectral library.

In some examples, the reference MS2 mass spectrum is obtained based on the reference dataset. To illustrate, the reference dataset may include measured and/or predicted MS2 mass spectrum for target ions (e.g., from previous mass analyses, from the full scan MS1 survey acquisition, from an in-silico predicted MS2 spectrum, from an existing dataset and/or library, etc.). Additionally or alternatively, the reference MS2 mass spectrum may be generated using a spectral simulation algorithm to simulate theoretical fragmentation spectra for each target ion represented in the reference dataset and/or inclusion list. In some implementations, such a spectral simulation algorithm may utilize machine learning models and/or tools to simulate theoretical fragmentation spectra. For example, the INFERYS™ deep learning algorithm by MSAID GmbH (Munich, Germany) provided in the PROTEOME DISCOVERER™ software provided by THERMO FISHER SCIENTIFIC (Waltham, MA) may be used.

The acquired MS2 mass spectrum may be determined to be within the threshold similarity of the reference MS2 mass spectrum by comparing the acquired MS2 mass spectrum with the reference MS2 mass spectrum and determining, based on the comparing, whether the acquired MS2 mass spectrum is within the threshold similarity of the reference MS2 mass spectrum. In some examples, a cross-correlation of the acquired MS2 mass spectrum and the reference MS2 mass spectrum is performed to determine when the acquired MS2 mass spectrum is within the threshold similarity of the reference MS2 mass spectrum. For example, the comparison may include determining a cross-correlation (XCorr) value of the acquired MS2 mass spectrum relative to the reference MS2 mass spectrum. When the cross-correlation value meets or exceeds a threshold, the cross-correlation value indicates a higher similarity between the acquired MS2 mass spectrum and the reference MS2 mass spectrum such that the acquired MS2 mass spectrum is determined to be within the threshold similarity. Alternatively, when the cross-correlation value is below the threshold, the cross-correlation value indicates a lower similarity between the acquired MS2 mass spectrum and the reference MS2 mass spectrum such that the acquired MS2 mass spectrum is determined to be outside of the threshold similarity. As an illustrative example, the acquired MS2 mass spectrum may be within the threshold similarity of the reference MS2 mass spectrum when peaks (e.g., m/z values, intensities, etc.) of the acquired MS2 mass spectrum align with peaks of the reference MS2 mass spectrum.

The acquired MS2 mass spectrum being within the threshold similarity of the reference MS2 mass spectrum verifies that the observed precursor ion identified in the MS1 mass spectrum does correspond to the target ion. Accordingly, the MS2 mass spectrum may be used to determine (e.g., confirm identification, determine quantity, and/or derive structural details, etc.) an analyte of interest included in the sample and associated with the target ion. Moreover, when the acquired MS2 mass spectrum is within the threshold similarity of the reference MS2 mass spectrum, the target ion is removed from the inclusion list (and/or added to an exclusion list) to exclude the target ion from another MS2 acquisition, allowing computing resources of mass spectrometer 104 to be available to identify additional observed precursor ions corresponding to additional target ions in the inclusion list. To illustrate, an MS2 mass spectrum may be acquired for the third precursor ion observed in mass spectrum 500 represented by third peak 502-3. By removing the target ion from the inclusion list to identify additional observed precursor ions and/or additional target ions, more analytes may be determined in sample 108 more efficiently.

Alternatively, the acquired MS2 mass spectrum being outside the threshold similarity of the reference MS2 mass spectrum may indicate that the observed precursor ion from the MS1 mass spectrum does not correspond to the target ion. Accordingly, when the acquired MS2 mass spectrum is outside the threshold similarity of the reference MS2 mass spectrum, the target ion may be maintained in the inclusion list (e.g., until a retention time window associated with the target ion has ended or until another acquired MS2 mass spectrum associated with the observed precursor ion is within the threshold similarity of the reference MS2 mass spectrum associated with the target ion). For example, one or more acquisition parameters for acquiring the MS2 mass spectrum associated with the observed precursor ion may be modified and another MS2 mass spectrum associated with the observed precursor may be acquired according to the one or more modified acquisition parameters. Moreover, another comparison of the additional MS2 mass spectrum acquired according to the modified acquisition parameters may be performed to determine whether the additional MS2 mass spectrum is within the threshold similarity of the reference MS2 mass spectrum.

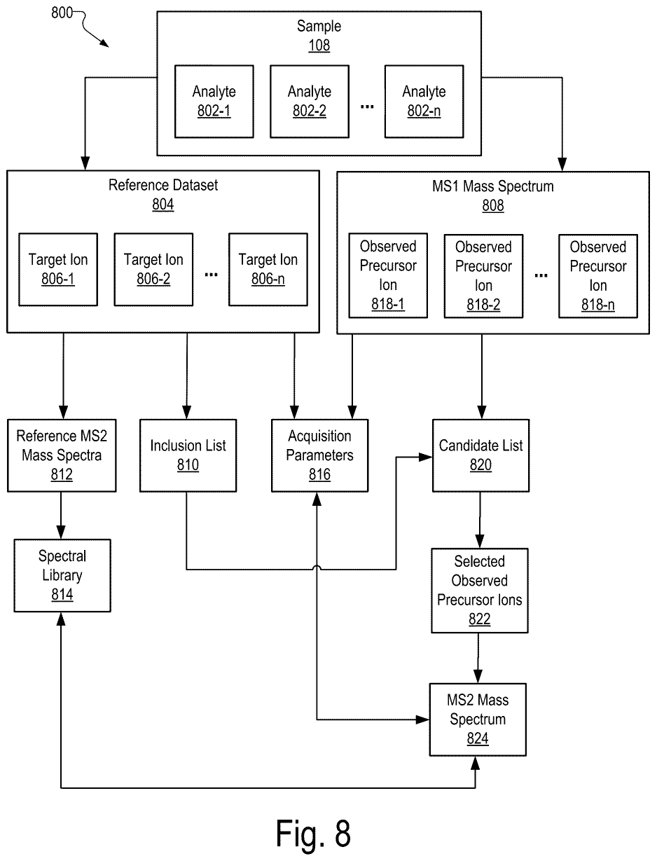

FIG. 8 shows an illustrative schematic 800 of performing reference-based data-dependent tandem mass spectrometry. As shown, sample 108 for mass analysis includes a plurality of analytes 802 (e.g., analytes 802-1 through 802-n). One or more analytes 802 may include an analyte of interest that is desired to be determined in sample 108. In some examples, such analytes of interest included in sample 108 are known prior to starting the mass analysis.

Based on sample 108, a reference dataset 804 is acquired that includes data representative of one or more target ions 806 (e.g., target ions 806-1 through 806-n). Target ions 806 are associated with one or more analytes 802 included in sample 108. For example, target ions 806 include ions that are known to be produced from and/or expected to be produced from analytes of interest included in analytes 802 of sample 108. The data representative of the one or more target ions may include spectral data associated with sample 108, a mapping of sample 108 to target ions 806, and/or one or more properties associated with target ions 806.

Reference dataset 804 may be acquired prior to the experiment, such as based on previously measured mass spectra and/or querying existing databases. For example, one or more analytes 802 included in sample 108 are known such that expected target ions 806 useful in determining the one or more known analytes 802 may be stored in a database and queried for generating reference dataset 804. Additionally or alternatively, reference dataset 804 may be acquired from a full scan MS1 survey acquisition of sample 108. For example, one or more target ions 806 may be identified in an MS1 mass spectrum (e.g., MS1 mass spectrum 808) generated based on the full scan MS1 survey acquisition, such as by identifying ions that correspond to m/z values at peaks in the MS1 mass spectrum.

Reference dataset 804 may be analyzed in order to characterize analytes 802 and/or target ions 806, as well as to extract or derive information associated with analytes 802 and/or target ions 806 that is useful for later spectral measurements. To illustrate, based on reference dataset 804, an inclusion list 810 is generated that includes one or more target ions 806 represented in reference dataset 804 that are useful in determining one or more analytes of interest in sample 108. For example, inclusion list 810 may include a selection of precursor ions with a high specificity towards an analyte 802 (e.g., precursor ions having unique peptides that describe only one protein). Alternatively, target ions 806 that are redundant and/or have a low likelihood of success of determining one or more analytes 802 may be omitted from inclusion list 810.

Additionally, reference MS2 mass spectra 812 associated with target ions 806 (e.g., included in inclusion list 810) are acquired based on reference dataset 804. As an illustrative example, known and/or expected product ions to be produced from target ions 806 are determined. This determination may involve different approaches that are selected based on one or more factors such as a sample, an application, and/or a workflow. One or more of these approaches may be referred to as “in-silico” theoretical fragmentation of the target ions. Each reference MS2 mass spectrum 812 associated with each target ion 806 are stored within a spectral library 814 such that the reference MS2 mass spectra 812 may be searched within spectral library 814.

Additionally, one or more acquisition parameters 816 (e.g., a collisional energy, a collection time, an acquisition time, an injection time, an elution time, a retention time, etc.) associated with target ions 806 are derived based on reference dataset 804, such as to tailor subsequent mass spectrum measurements. For example, based on reference dataset 804, one or more of an expected intensity, m/z values, and/or a charge state of target ions 806 can be estimated such as to adjust collection times and/or acquisition times associated with target ions 806. Additionally, retention time windows, order of elution, and/or elution profiles of target ions 806 can be determined based on reference dataset 804 such as to select optimal time points for detecting a particular analyte 802. Additionally, possible interferences between target ions 806 and/or other ions (e.g., ions not in the inclusion list) can be predicted based on reference dataset 804 such as to avoid such interferences. Additionally, chemical compositions and/or structural data of target ions 806 can be extracted based on reference dataset 804 such as to predict MS2 mass spectra (e.g., reference MS2 mass spectra 812). Such acquisition parameters 816 may be set so that an MS2 acquisition of sample 108 is performed according to acquisition parameters 816.

Moreover, an MS1 mass spectrum 808 is acquired of ions produced from sample 108. MS1 mass spectrum 808 may include intensity values representative of observed precursor ions 818 (e.g., observed precursor ions 818-1 through 818-n) produced from analytes 802 included in sample 108 as a function of m/z. For example, MS1 mass spectrum 808 may include a plurality of peaks at various m/z indicative of the relative abundance of precursor ions corresponding to the m/z that are observed by mass spectrometer 104 during the MS1 acquisition. In some examples, MS1 mass spectrum is acquired from performing a full scan MS1 survey acquisition that may be used for generating reference dataset 804.

Based on MS1 mass spectrum 808, a candidate list 820 is generated that includes observed precursor ions 818 identified in MS1 mass spectrum 808 and that correspond to target ions 806 in inclusion list 810. For example, observed precursor ions 818 associated with m/z values that are the same or similar to m/z values associated with target ions 806 are determined to correspond to target ions 806. In some examples, observed precursor ions 818 included in candidate list 820 are prioritized such as by ranking observed precursor ions 818 in candidate list 820. For example, observed precursor ions 818 may be ranked according to one or more factors such as one or more of an intensity, a likelihood of determining one or more analytes 802, expected product ions, or interferences.

From candidate list 820, a set of selected one or more observed precursor ions 822 are selected for MS2 acquisition. Selected observed precursor ions 822 may include observed precursor ions 818 that are ranked above other observed precursor ions 818 in candidate list 820 such that higher ranking observed precursor ions 818 are selected for MS2 acquisition. Moreover, selected observed precursor ions 822 are selected based on satisfying one or more criteria (e.g., intensity, charge state, m/z values, m/z ranges, time periods, isotope distribution, etc.). As an illustrative example, an observed precursor ion 818 may be selected from candidate list 820 when an intensity associated with the observed precursor ion 818 satisfies an intensity threshold and/or a charge state associated with the observed precursor ion 818 satisfies a charge state requirement. Accordingly, an observed precursor ion 818 selected for MS2 acquisition is selected from candidate list 820 when the observed precursor ion 818 satisfies the one or more criteria and corresponds to a target ion 806 included in inclusion list 810.

An MS2 mass spectrum 824 is acquired for one or more of selected observed precursor ions 822 according to one or more acquisition parameters 816. In some examples, one or more acquisition parameters 816 are updated based on MS1 mass spectrum 808. To illustrate, the one or more acquisition parameters 816 may include a retention time window associated with one or more target ions 806. Based on MS1 mass spectrum 808, a retention time shift relative to the retention time window may be determined for observed precursor ions 818 corresponding to the one or more target ions 806. For example, MS1 mass spectrum 808 may indicate that a retention time window shifted earlier or later in the mass analysis (e.g., due to an amount of time for ions to be transmitted through LC-MS system 100). The retention time window may thereby be modified according to the retention time shift such that MS2 mass spectrum 824 is acquired based on the modified retention time window.

Each MS2 mass spectrum 824 acquired based on the one or more selected observed precursor ions 822 may be compared with reference MS2 mass spectra 812 in spectral library 814. For example, a real-time search of spectral library 814 may be performed during run-time of mass spectrometer 104 (e.g., after acquiring each MS2 mass spectrum 820), such as to identify and compare a reference MS2 mass spectrum 812 associated with a target ion 806 with an acquired MS2 mass spectrum associated with the selected observed precursor ion 822.

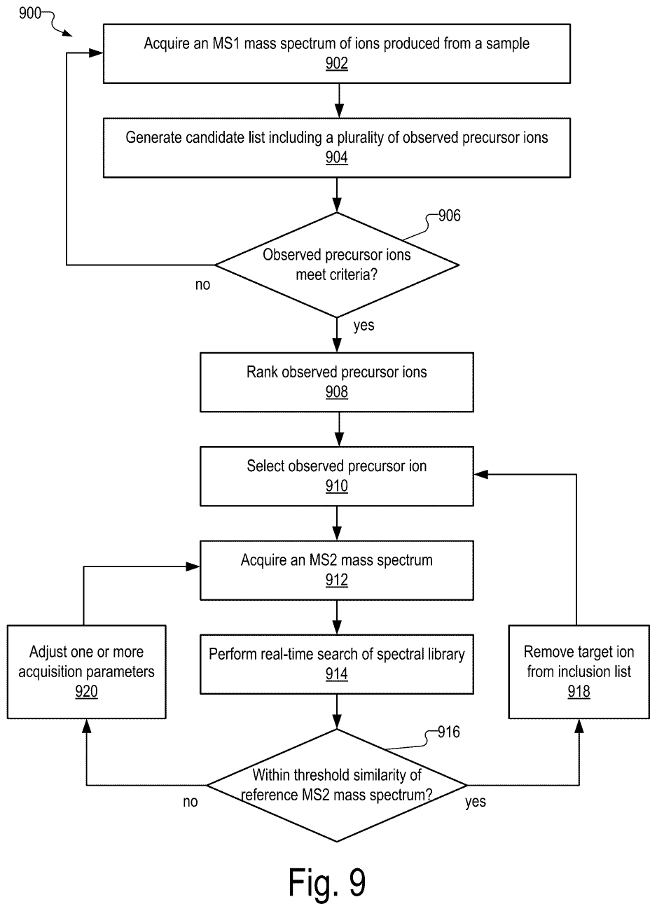

FIG. 9 shows an illustrative method 900 of performing reference-based data-dependent tandem mass spectrometry. While FIG. 9 shows illustrative operations according to one embodiment, other embodiments may omit, add to, reorder, and/or modify any of the operations shown in FIG. 9. One or more of the operations shown in FIG. 9 may be performed by LC-MS system 100, mass spectrometer 104, and/or system 300, any components included therein, and/or any implementations thereof.

As shown, in operation 902, an MS1 mass spectrum (e.g., MS1 mass spectrum 808) is acquired of ions produced from a sample (e.g., sample 108). The acquiring the MS1 mass spectrum further includes identifying one or more observed precursor ions (e.g., observed precursor ions 818) in the MS1 mass spectrum. The acquisition of the MS1 mass spectrum for the ions may be performed in any suitable way, such as by ion source 202 of mass spectrometer 104 directing ions to mass analyzer 204-1. Mass analyzer 204-1 filters and detects the precursor ions and sends data representative of the detections to controller 206. Based on the data, controller 206 generates the MS1 mass spectrum.

In operation 904, a candidate list (e.g., candidate list 820) is generated that includes a plurality of observed precursor ions observed in the MS1 mass spectrum and that correspond to target ions (e.g., target ions 806) included in an inclusion list (e.g., inclusion list 810).

In some examples, the inclusion list may be adjusted after one or more samples have been subjected to MS1 analysis, based on observations from the MS1 analysis. For example, after the MS1 mass spectrum is acquired to identify observed precursor ions, the inclusion list may be refined based on the observed precursor ions observed in the MS1 mass spectrum. In some examples, the refinement includes replacing, in the inclusion list, data representative of one or more expected precursor ions with data representative of one or more of the observed precursor ions observed in the MS1 mass spectrum. In some examples, the refinement includes adding, to the inclusion list, data representative of any of the observed precursor ions that are not duplicative of the expected precursor ions already represented in the inclusion list. In some examples, the refinement includes removing, from the inclusion list any of the expected observed ions that are not among the precursor ions observed in the MS1 analysis.

In operation 906, observed precursor ions included in the candidate list are compared to one or more criteria to determine whether the observed precursor ions meet the one or more criteria. As illustrative examples, m/z values associated with each observed precursor ion in the candidate list may be determined to be within a select m/z range, an intensity associated with each observed precursor ion may be determined to exceed an intensity threshold, and/or a charge state associated with each observed precursor ion may be determined to satisfy a charge state requirement. If none of the observed precursor ions included in the candidate list meet the one or more criteria (e.g., no, at operation 906), another MS1 mass spectrum may be acquired. Alternatively, if one or more of the observed precursor ions included in the candidate list meet the one or more criteria (e.g., yes, at operation 906), in operation 908, the one or more observed precursor ions that meet the one or more criteria are ranked.

For example, the observed precursor ions are ranked according to one or more factors such as one or more of an intensity, a likelihood of determining one or more analytes, expected product ions, or interferences. To illustrate, a precursor ion having a higher intensity may be ranked above another precursor ion having a lower intensity, a precursor ion having a higher likelihood of determining one or more analytes may be ranked above another precursor ion having a lower likelihood, a precursor ion having more unique product ions may be ranked above another precursor ion having a lower unique product ions, and/or a precursor ion having less interference may be ranked above another precursor ion having more interference. In some examples, the one or more factors are weighted to rank plurality of observed precursor ions (e.g., likelihood of determining one or more analytes included in the sample based on the observed precursor ions may be weighted above the intensity of the observed precursor ions).

In some examples, a scoring algorithm may be defined and used to determine and assign product-ion-likelihood scores to the precursor ions observed in the MS1 mass spectrum. An assigned score may represent a determined likelihood that an observed precursor ion produces a unique product ion for determining one or more analytes in the sample. The assigned scores may be used to rank the observed precursor ions (e.g., from a higher likelihood to a lower likelihood) and/or to compare the observed precursor ions against a score threshold. The results of the ranking and/or comparison may be used to determine whether to select observed ions for MS2 analysis or exclude observed precursor ions from MS2 analysis. For example, precursor ions having assigned scores above other precursor ions and/or having assigned scores above the threshold (or below the threshold in alternative implementations) may be selected for MS2 analysis. Thus, based on a scoring algorithm, MS2 scans may be performed in an order that is selected based on product-ion-likelihood scores.

In operation 910, an observed precursor ion from the ranked precursor ions is selected for MS2 acquisition. The selected observed precursor (e.g., selected precursor ion 822) ion may include the observed precursor ion that is ranked above other observed precursor ions in the candidate list that meets the one or more criteria. For example, a subset of the precursor ions observed in the MS1 mass spectrum may be selected for MS2 analysis in order from highest ranked precursor ions to lowest ranked precursor ions (e.g., highest to lowest product-ion-likelihood scores).

In operation 912, an MS2 mass spectrum (e.g., MS2 mass spectrum 824) is acquired for the selected observed precursor ion as according to one or more acquisition parameters (e.g., acquisition parameters 816). For example, the MS2 mass spectrum may be acquired for the selected observed precursor ion during an expected retention time window for the target ion corresponding to the selected observed precursor ion and/or by applying a particular collisional energy in collision cell 204-2 that may produce certain product ions from the selected observed precursor ion. The acquisition of the MS2 mass spectrum for the observed precursor ion may be performed in any suitable way, such as by mass analyzer 204-1 of mass spectrometer 104 directing ions having the m/z values of the observed precursor ion to collision cell 204-2, where the ions undergo one or more dissociation processes to produce product ions that are directed to mass analyzer 204-3. Mass analyzer 204-3 filters and detects the product ions and sends data representative of the detections to controller 206. Based on the data, controller 206 generates the MS2 mass spectrum of product ions produced by fragmenting the observed precursor ions.

In operation 914, a real-time search of a spectral library is performed. For example, the spectral library is searched for a reference MS2 mass spectrum (e.g., reference MS2 mass spectrum 812) that is expected for the target ion corresponding to the selected observed precursor ion associated with the acquired MS2 mass spectrum. The search of the spectral library is performed in real-time (e.g., during runtime of the mass analysis). Based on the real-time library search, a reference MS2 mass spectrum is identified that is associated with the target ion corresponding to the selected observed precursor ion associated with the acquired MS2 mass spectrum.

In operation 916, the acquired MS2 mass spectrum is compared with the reference MS2 mass spectrum to determine whether the acquired MS2 mass spectrum is within a threshold similarity of the reference MS2 mass spectrum. For example, the comparison may include determining an XCorr value of the acquired MS2 mass spectrum relative to the reference MS2 mass spectrum. When the XCorr value meets or exceeds a threshold, the XCorr value indicates a higher similarity between the acquired MS2 mass spectrum and the reference MS2 mass spectrum such that the acquired MS2 mass spectrum is determined to be within a threshold similarity of the reference MS2 mass spectrum. Still other suitable ways to determine whether the acquired MS2 mass spectrum is within the threshold similarity of the reference MS2 mass spectrum. To illustrate, the acquired MS2 mass spectrum may be determined to be within the threshold similarity when one or more peaks associated with one or more m/z values of the acquired MS2 mass spectrum align with the reference MS2 mass spectrum.

If the acquired MS2 mass spectrum is within the threshold similarity (e.g., yes, at operation 916), in operation 918, the target ion corresponding to the selected observed precursor ion associated with the acquired MS2 mass spectrum is removed from the inclusion list. For example, when the acquired MS2 mass spectrum is within the threshold similarity of the reference MS2 mass spectrum, the observed precursor ion is verified to correspond to the target ion such that the acquired MS2 mass spectrum may be used to determine (e.g., confirm identification, determine quantity, and/or derive structural details, etc.) an analyte of interest included in the sample and associated with the target ion. Moreover, removing the target ion from the inclusion list excludes the target ion from another MS2 acquisition, allowing computing resources of mass spectrometer 104 to be available to identify additional observed precursor ions included in the candidate list. For example, another observed precursor ion, such as the next highest ranked precursor ion, may be selected for MS2 acquisition (e.g., at operation 910) to confirm the presence of another target ion in the sample. In some examples, the target ion is removed from the inclusion list before the retention time window associated with the target ion has ended such that another observed precursor ion corresponding to another target ion may be selected for MS2 acquisition during the same retention time window and/or prior to the end of the retention time window.

In some examples, target ions removed from the inclusion list are further added to an exclusion list used to exclude the target ions from MS2 analysis in operation 912. The exclusion list may be used for any suitable length of time to exclude the target ions from MS2 analysis. In some implementations, after the suitable length of time, one or more of the target ions may be removed from the exclusion list if those one or more target ions stop corresponding to precursor ions observed in the MS1 mass spectrum.

Alternatively, if the acquired MS2 mass spectrum is outside of the threshold similarity (e.g., no, at operation 916), the selected observed precursor ion is not verified to correspond to the target ion. Accordingly, the target ion may be maintained in the inclusion list and, in operation 920, the one or more acquisition parameters associated with the MS2 acquisition of the selected observed precursor ion may be modified. To illustrate, a collisional energy used to fragment the observed precursor ion may be modified and/or a maximum injection time for the observed precursor ion may be increased. Based on the modified one or more acquisition parameters, another MS2 mass spectrum associated with the observed precursor may be acquired according to the one or more modified acquisition parameters at operation 912. Operations 914 and 916 may be repeated for the additionally acquired MS2 mass spectrum. If the additionally acquired MS2 mass spectrum is within the threshold similarity (e.g., yes, at operation 916), the target ion is then removed from the inclusion list at operation 918. Alternatively, if the additionally acquired MS2 mass spectrum is not within the threshold similarity (e.g., no, at operation 916), the target ion may be maintained in the inclusion list until a retention time window associated with the target ion has ended and/or the one or more acquisition parameters may be adjusted again for another MS2 acquisition associated with the observed precursor ion at operation 920.

Performance of operations 910-920 may be repeated for other observed precursor ions included in the candidate list such as until there are no remaining observed precursor ions of the MS1 mass spectrum to be considered, or the DDA procedure is terminated for another reason.

In some examples, a DDA procedure may be performed in real time or near real time as part of a method of data-dependent tandem mass spectrometry. For example, operations of any of the methods described herein may be performed in real time or near real time as part of a method of data-dependent tandem mass spectrometry. This may include real-time searching of ions observed in an MS1 mass spectrum to dynamically select, from those ions, which ions to subject to or exclude from MS2 analysis.

While certain examples are described herein in the context of tandem mass spectrometry, illustrative systems and methods described herein may be implemented and used for data-dependent mass spectrometry in any suitable mass spectrometry configuration, such as in any multi-stage mass spectrometer. Moreover, while certain illustrative examples are described herein in the context of precursor ions being identified and excluded from MS2 analysis, the principles described herein may be applied to any version of a product ion.

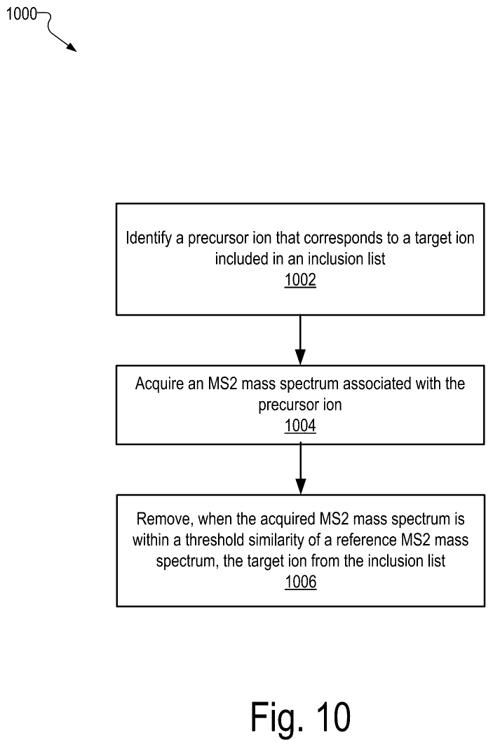

As an illustrative example, one or more precursor ions may be selected for an MS2 acquisition without acquiring an MS1 mass spectrum, such as in a targeted approach (e.g., Selected Reaction Monitoring (SRM), Multiple Reaction Monitoring (MRM), etc.). For example, FIG. 10 shows an illustrative method 1000 of performing targeted reference-based data-dependent tandem mass spectrometry. While FIG. 10 shows illustrative operations according to one embodiment, other embodiments may omit, add to, reorder, and/or modify any of the operations shown in FIG. 10. One or more of the operations shown in FIG. 10 may be performed by LC-MS system 100, mass spectrometer 104, and/or system 300, any components included therein, and/or any implementations thereof.

As shown, in operation 1002, a precursor ion is identified that corresponds to a target ion included in an inclusion list that is used to select one or more precursor ions for an MS2 acquisition. For example, the inclusion list includes one or more ions (e.g., precursor ions and/or product ions) known to be and/or expected to be in the sample that are desired for analysis (e.g., each target ion is informative in determining one or more analytes of interest known to be and/or expected to be in the sample and desired for analysis such that the one or more analytes may be determined based on mass analysis of the target ion). In some examples, the inclusion list of one or more target ions is generated based on a reference dataset including data representative of one or more target ions associated with sample 108. The identifying the precursor ion includes selecting a target ion from the inclusion list and identifying a precursor ion that corresponds to the target ion (e.g., without acquiring an MS1 mass spectrum).

In operation 1004, an MS2 mass spectrum associated with the precursor ion is acquired. For example, acquiring the MS2 mass spectrum includes directing mass spectrometer 104 to acquire the MS2 mass spectrum, such as by directing mass spectrometer 104 to isolate and fragment precursor ions having a narrow range of m/z values that includes the m/z values of the identified precursor ion. Mass spectrometer 104 is further directed to acquire the MS2 mass spectrum based on the isolated and fragmented precursor ions having the narrow range of m/z values. For example, the retention time window is set to a time allotted in the inclusion list for m/z values associated with the target ion in the inclusion list (e.g., without reference to an MS1 mass spectrum). If two or more target ions are active within the same retention time window in the inclusion list, the one or more target ions are sequentially triggered until the end of the retention time window allotted in the inclusion list.

In operation 1006, when the acquired MS2 mass spectrum associated with the precursor ion is within a threshold similarity of a reference MS2 mass spectrum associated with the target ion, the target ion is removed from the inclusion list. The reference MS2 mass spectrum associated with the target ion may include a known and/or expected MS2 mass spectrum associated with the target ion. In some examples, a reference MS2 spectrum for each target ion is stored within a spectral library such that operation 1006 may include performing a real-time search of the spectral library to identify the reference MS2 mass spectrum associated with the target ion.

When the acquired MS2 mass spectrum is within the threshold similarity of the reference MS2 mass spectrum, the identified precursor ion is sufficiently similar to the target ion and is verified to be included in the sample. When the precursor ion is verified to be included in the sample, the target ion is removed from the inclusion list to prevent acquiring additional MS2 mass spectra for the target ion. Accordingly, removing the target ion from the inclusion list may allow additional MS2 mass spectra to be acquired based on additional precursor ions corresponding to additional target ions, such as during the same retention time window (e.g., to increase a number of target ions able to be effectively measured by mass spectrometer 104).

Alternatively, the acquired MS2 mass spectrum being outside the threshold similarity of the reference MS2 mass spectrum may indicate that the identified precursor ion does not correspond to the target ion and/or is not included in the sample. Accordingly, when the acquired MS2 mass spectrum is outside the threshold similarity of the reference MS2 mass spectrum, the target ion may be maintained in the inclusion list (e.g., until a retention time window associated with the target ion has ended or until another acquired MS2 mass spectrum associated with the precursor ion is within the threshold similarity of the reference MS2 mass spectrum associated with the target ion). For example, one or more acquisition parameters for acquiring the MS2 mass spectrum associated with the identified precursor ion may be modified and another MS2 mass spectrum associated with the identified precursor may be acquired according to the one or more modified acquisition parameters. Moreover, another comparison of the additional MS2 mass spectrum acquired according to the modified acquisition parameters may be performed to determine whether the additional MS2 mass spectrum is within the threshold similarity of the reference MS2 mass spectrum.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions such as a computer program product embodied on the computer-readable medium) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

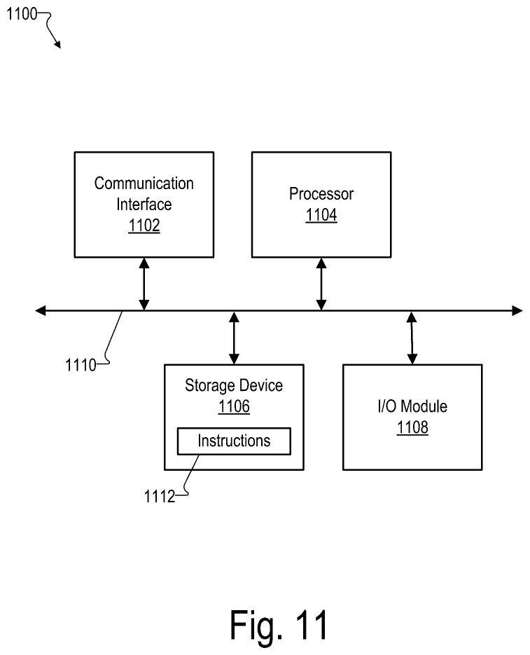

FIG. 11 shows an illustrative computing device 1100 that may be specifically configured to perform one or more of the processes described herein. As shown in FIG. 11, computing device 1100 may include a communication interface 1102, a processor 1104, a storage device 1106, and an input/output (“I/O”) module 1108 communicatively connected one to another via a communication infrastructure 1110. While an illustrative computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, an audio/video connection, and any other suitable interface.

Processor 1104 generally represents any type or form of processing unit capable of processing data and/or interpreting, executing, and/or directing execution of one or more of the instructions, processes, and/or operations described herein. Processor 1104 may perform operations by executing computer-executable instructions 1112 (e.g., an application, software, code, and/or other executable data instance) stored in storage device 1106.

Storage device 1106 may include one or more data storage media, devices, or configurations and may employ any type, form, and combination of data storage media and/or device. For example, storage device 1106 may include, but is not limited to, any combination of the non-volatile media and/or volatile media described herein. Electronic data, including data described herein, may be temporarily and/or permanently stored in storage device 1106. For example, data representative of computer-executable instructions 1112 configured to direct processor 1104 to perform any of the operations described herein may be stored within storage device 1106. In some examples, data may be arranged in one or more databases residing within storage device 1106.

I/O module 1108 may include one or more I/O modules configured to receive user input and provide user output. One or more I/O modules may be used to receive input for a single virtual experience. I/O module 1108 may include any hardware, firmware, software, or combination thereof supportive of input and output capabilities. For example, I/O module 1108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 1100. For example, storage facility 302 may be implemented by storage device 1106, and processing facility 304 may be implemented by processor 1104.

Advantages and features of the present disclosure can be further described by the following statements:
1. A system comprising: a memory storing instructions; and one or more processors communicatively coupled to the memory and configured to execute the instructions to perform a process comprising: directing a mass spectrometer to acquire an MS1 mass spectrum of ions produced from a sample; identifying, based on the MS1 mass spectrum, an observed precursor ion that corresponds to a target ion included in an inclusion list, wherein the inclusion list is used to select one or more precursor ions observed in the MS1 spectrum for an MS2 acquisition; directing, based on the identifying of the observed precursor ion, the mass spectrometer to acquire an MS2 mass spectrum associated with the observed precursor ion; and removing, when the acquired MS2 mass spectrum associated with the observed precursor ion is within a threshold similarity of a reference MS2 mass spectrum associated with the target ion, the target ion from the inclusion list.
2. The system of any one of the preceding statements, wherein the process further comprises providing a reference dataset that includes data representative of one or more target ions included in the sample.
3. The system of any one of the preceding statements, wherein the process further comprises generating, based on the reference dataset, the inclusion list including the one or more target ions.
4. The system of any one of the preceding statements, wherein the process further comprises obtaining, based on the reference dataset, the reference MS2 mass spectrum.
5. The system of any one of the preceding statements, wherein the process further comprises: determining, based on the reference dataset, a retention time window associated with the one or more target ions; determining a retention time shift relative to the retention time window associated with the one or more target ions; and modifying the retention time window according to the retention time shift, wherein the MS2 mass spectrum is acquired based on the modified retention time window.
6. The system of any one of the preceding statements, wherein the reference dataset is acquired based on a pooled sample of a combination of multiple samples.
7. The system of any one of the preceding statements, wherein the identifying the observed precursor ion comprises: generating, based on the MS1 mass spectrum, a candidate list including a plurality of observed precursor ions; and selecting the observed precursor ion from the candidate list when the observed precursor ion corresponds to a target ion included in the inclusion list and meets one or more criteria.
8. The system of any one of the preceding statements, wherein the selecting the observed precursor ion is based on ranking the plurality of observed precursor ions included in the candidate list, wherein the selected observed precursor ion is ranked above another observed precursor ion included in the candidate list.
9. The system of any one of the preceding statements, wherein the ranking the plurality of observed precursor ions is based on one or more of an intensity of each observed precursor ion included in the plurality of observed precursor ions, a likelihood of determining one or more analytes included in the sample based on each observed precursor ion included in the plurality of observed precursor ions, unique product ions expected to be produced from each observed precursor ion included in the plurality of observed precursor ions, or interference associated with each observed precursor ion included in the plurality of observed precursor ions.
10. The system of any one of the preceding statements, wherein the process further comprises: comparing the acquired MS2 mass spectrum with the reference MS2 mass spectrum; and determining, based on the comparing the acquired MS2 mass spectrum with the reference MS2 mass spectrum, whether the acquired MS2 mass spectrum is within the threshold similarity of the reference MS2 mass spectrum.
11. The system of any one of the preceding statements, wherein the reference MS2 mass spectrum is stored within a spectral library such that the comparing the acquired MS2 mass spectrum with the reference MS2 mass spectrum includes performing a real time search of the spectral library.
12. The system of any one of the preceding statements, wherein the removing the target ion from the inclusion list is configured to exclude the target ion from another MS2 acquisition.
13. The system of any one of the preceding statements, wherein the directing the mass spectrometer to acquire the MS2 mass spectrum includes setting one or more acquisition parameters associated with the observed precursor ion and directing the mass spectrometer to acquire the MS2 mass spectrum according to the one or more acquisition parameters.
14. The system of any one of the preceding statements, wherein the process further comprises, when the MS2 mass spectrum associated with the observed precursor ion is outside the threshold similarity of the reference MS2 mass spectrum associated with the target ion, adjusting the one or more acquisition parameters associated with the observed precursor ion and directing the mass spectrometer to acquire another MS2 mass spectrum associated with the observed precursor ion according to the adjusted one or more acquisition parameters.
15. The system of any one of the preceding statements, wherein the process further comprises, when the when the MS2 mass spectrum associated with the observed precursor ion is outside the threshold similarity of the reference MS2 mass spectrum associated with the target ion, maintaining the target ion on the inclusion list until a retention time window associated with the target ion has ended or until another acquired MS2 mass spectrum associated with the observed precursor ion is within the threshold similarity of the reference MS2 mass spectrum associated with the target ion.
16. The system of any one of the preceding statements, wherein the process further comprises: identifying, based on the MS1 mass spectrum, an additional observed precursor ion that corresponds to an additional target ion included in the inclusion list; and directing, based on the identifying of the additional observed precursor ion, the mass spectrometer to acquire an MS2 mass spectrum associated with the additional observed precursor ion.
17. The system of any one of the preceding statements, wherein the process further comprises removing, when the acquired MS2 mass spectrum associated with the additional observed precursor ion is within a threshold similarity of another reference MS2 mass spectrum associated with the additional target ion, the additional target ion from the inclusion list.
18. The system of any one of the preceding statements, wherein the process further comprises, when the MS2 mass spectrum associated with the observed precursor ion is within the threshold similarity of the reference MS2 mass spectrum associated with the target ion, determining one or more analytes included in the sample.
19. A system comprising: a mass spectrometer configured to acquire mass spectra for ions produced from a sample; and a controller communicatively coupled with the mass spectrometer and configured to: direct the mass spectrometer to acquire an MS1 mass spectrum of ions produced from the sample; identify, based on the MS1 mass spectrum, an observed precursor ion that corresponds to a target ion included in an inclusion list, wherein the inclusion list is used to select one or more precursor ions observed in the MS1 spectrum for an MS2 acquisition; direct, based on the identifying of the observed precursor ion, the mass spectrometer to acquire an MS2 mass spectrum associated with the observed precursor ion; and remove, when the acquired MS2 mass spectrum associated with the observed precursor ion is within a threshold similarity of a reference MS2 mass spectrum associated with the target ion, the target ion from the inclusion list.
20. A non-transitory computer-readable medium storing instructions that, when executed, direct at least one processor of a computing device for mass spectrometry to perform a process comprising: directing a mass spectrometer to acquire an MS1 mass spectrum of ions produced from a sample; identifying, based on the MS1 mass spectrum, an observed precursor ion that corresponds to a target ion included in an inclusion list, wherein the inclusion list is used to select one or more precursor ions observed in the MS1 spectrum for an MS2 acquisition; directing, based on the identifying of the observed precursor ion, the mass spectrometer to acquire an MS2 mass spectrum associated with the observed precursor ion; and removing, when the acquired MS2 mass spectrum associated with the observed precursor ion is within a threshold similarity of a reference MS2 mass spectrum associated with the target ion, the target ion from the inclusion list.
21. A system comprising: a memory storing instructions; and one or more processors communicatively coupled to the memory and configured to execute the instructions to perform a process comprising: identifying a precursor ion that corresponds to a target ion included in an inclusion list, wherein the inclusion list is used to select one or more precursor ions for an MS2 acquisition; directing, based on the identifying of the precursor ion, the mass spectrometer to acquire an MS2 mass spectrum associated with the precursor ion; and removing, when the acquired MS2 mass spectrum associated with the precursor ion is within a threshold similarity of a reference MS2 mass spectrum associated with the target ion, the target ion from the inclusion list.

It will be recognized by those of ordinary skill in the art that while, in the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a memory storing instructions; and
one or more processors communicatively coupled to the memory and configured to execute the instructions to perform a process comprising:
directing a mass spectrometer to acquire an MS1 mass spectrum of ions produced from a sample;
identifying, based on the MS1 mass spectrum, an observed precursor ion that corresponds to a target ion included in an inclusion list, wherein the inclusion list is used to select one or more precursor ions observed in the MS1 spectrum for an MS2 acquisition;
directing, based on the identifying of the observed precursor ion, the mass spectrometer to acquire an MS2 mass spectrum associated with the observed precursor ion; and
removing, when the acquired MS2 mass spectrum associated with the observed precursor ion is within a threshold similarity of a reference MS2 mass spectrum associated with the target ion, the target ion from the inclusion list.

2. The system of claim 1, wherein the process further comprises providing a reference dataset that includes data representative of one or more target ions included in the sample.

3. The system of claim 2, wherein the process further comprises generating, based on the reference dataset, the inclusion list including the one or more target ions.

4. The system of claim 2, wherein the process further comprises obtaining, based on the reference dataset, the reference MS2 mass spectrum.

5. The system of claim 2, wherein the process further comprises:
determining, based on the reference dataset, a retention time window associated with the one or more target ions;
determining a retention time shift relative to the retention time window associated with the one or more target ions; and
modifying the retention time window according to the retention time shift, wherein the MS2 mass spectrum is acquired based on the modified retention time window.

6. The system of claim 2, wherein the reference dataset is acquired based on a pooled sample of a combination of multiple samples.

7. The system of claim 1, wherein the identifying the observed precursor ion comprises:
generating, based on the MS1 mass spectrum, a candidate list including a plurality of observed precursor ions; and
selecting the observed precursor ion from the candidate list when the observed precursor ion corresponds to a target ion included in the inclusion list and meets one or more criteria.

8. The system of claim 7, wherein the selecting the observed precursor ion is based on ranking the plurality of observed precursor ions included in the candidate list, wherein the selected observed precursor ion is ranked above another observed precursor ion included in the candidate list.

9. The system of claim 8, wherein the ranking the plurality of observed precursor ions is based on one or more of an intensity of each observed precursor ion included in the plurality of observed precursor ions, a likelihood of determining one or more analytes included in the sample based on each observed precursor ion included in the plurality of observed precursor ions, unique product ions expected to be produced from each observed precursor ion included in the plurality of observed precursor ions, or interference associated with each observed precursor ion included in the plurality of observed precursor ions.

10. The system of claim 1, wherein the process further comprises:
comparing the acquired MS2 mass spectrum with the reference MS2 mass spectrum; and
determining, based on the comparing the acquired MS2 mass spectrum with the reference MS2 mass spectrum, whether the acquired MS2 mass spectrum is within the threshold similarity of the reference MS2 mass spectrum.

11. The system of claim 10, wherein the reference MS2 mass spectrum is stored within a spectral library such that the comparing the acquired MS2 mass spectrum with the reference MS2 mass spectrum includes performing a real time search of the spectral library.

12. The system of claim 1, wherein the removing the target ion from the inclusion list is configured to exclude the target ion from another MS2 acquisition.

13. The system of claim 1, wherein the directing the mass spectrometer to acquire the MS2 mass spectrum includes setting one or more acquisition parameters associated with the observed precursor ion and directing the mass spectrometer to acquire the MS2 mass spectrum according to the one or more acquisition parameters.

14. The system of claim 13, wherein the process further comprises, when the MS2 mass spectrum associated with the observed precursor ion is outside the threshold similarity of the reference MS2 mass spectrum associated with the target ion, adjusting the one or more acquisition parameters associated with the observed precursor ion and directing the mass spectrometer to acquire another MS2 mass spectrum associated with the observed precursor ion according to the adjusted one or more acquisition parameters.

15. The system of claim 1, wherein the process further comprises, when the MS2 mass spectrum associated with the observed precursor ion is outside the threshold similarity of the reference MS2 mass spectrum associated with the target ion, maintaining the target ion on the inclusion list until a retention time window associated with the target ion has ended or until another acquired MS2 mass spectrum associated with the observed precursor ion is within the threshold similarity of the reference MS2 mass spectrum associated with the target ion.

16. The system of claim 1, wherein the process further comprises:
identifying, based on the MS1 mass spectrum, an additional observed precursor ion that corresponds to an additional target ion included in the inclusion list; and
directing, based on the identifying of the additional observed precursor ion, the mass spectrometer to acquire an MS2 mass spectrum associated with the additional observed precursor ion.

17. The system of claim 16, wherein the process further comprises removing, when the acquired MS2 mass spectrum associated with the additional observed precursor ion is within a threshold similarity of another reference MS2 mass spectrum associated with the additional target ion, the additional target ion from the inclusion list.

18. The system of claim 1, wherein the process further comprises, when the MS2 mass spectrum associated with the observed precursor ion is within the threshold similarity of the reference MS2 mass spectrum associated with the target ion, determining one or more analytes included in the sample.

19. A system comprising:
a mass spectrometer configured to acquire mass spectra for ions produced from a sample; and
a controller communicatively coupled with the mass spectrometer and configured to:
direct the mass spectrometer to acquire an MS1 mass spectrum of ions produced from the sample;
identify, based on the MS1 mass spectrum, an observed precursor ion that corresponds to a target ion included in an inclusion list, wherein the inclusion list is used to select one or more precursor ions observed in the MS1 spectrum for an MS2 acquisition;
direct, based on the identifying of the observed precursor ion, the mass spectrometer to acquire an MS2 mass spectrum associated with the observed precursor ion; and
remove, when the acquired MS2 mass spectrum associated with the observed precursor ion is within a threshold similarity of a reference MS2 mass spectrum associated with the target ion, the target ion from the inclusion list.

20. A non-transitory computer-readable medium storing instructions that, when executed, direct at least one processor of a computing device for mass spectrometry to perform a process comprising:
directing a mass spectrometer to acquire an MS1 mass spectrum of ions produced from a sample;
identifying, based on the MS1 mass spectrum, an observed precursor ion that corresponds to a target ion included in an inclusion list, wherein the inclusion list is used to select one or more precursor ions observed in the MS1 spectrum for an MS2 acquisition;
directing, based on the identifying of the observed precursor ion, the mass spectrometer to acquire an MS2 mass spectrum associated with the observed precursor ion; and
removing, when the acquired MS2 mass spectrum associated with the observed precursor ion is within a threshold similarity of a reference MS2 mass spectrum associated with the target ion, the target ion from the inclusion list.

21. A system comprising:
a memory storing instructions; and
one or more processors communicatively coupled to the memory and configured to execute the instructions to perform a process comprising:
identifying a precursor ion that corresponds to a target ion included in an inclusion list, wherein the inclusion list is used to select one or more precursor ions for an MS2 acquisition;
directing, based on the identifying of the precursor ion, the mass spectrometer to acquire an MS2 mass spectrum associated with the precursor ion; and
removing, when the acquired MS2 mass spectrum associated with the precursor ion is within a threshold similarity of a reference MS2 mass spectrum associated with the target ion, the target ion from the inclusion list.
